(19) United States
(12) Patent Application Publication
(10) Pub. No.: US 2004/0186903 A1
(43) Pub. Date: Sep. 23, 2004

(54) Remote support of an IT infrastructure

(76) Inventor: Bernd Lambertz, Gaertringen (DE)

Correspondence Address: HEWLETT-PACKARD COMPANY, Intellectual Property Administration, P. O. Box 272400, Fort Collins, CO, 80527-2400, US

(21) Appl. No.: 10/391,559

(22) Filed: Mar. 20, 2003

(51) Int. Cl. G06F 15/173

(52) U.S. Cl. 709/224; 709/203

(57) ABSTRACT

A method of providing an automated remote IT network support service is provided. The method has the following steps: Information about a customer's IT infrastructure is collected. A data representation of at least part of the IT infrastructure is generated from the collected data. The data representation is transferred to a support service provider via a network connection. The data representations taken at different points in time are compared to find differences and changes of the IT infrastructure. The differences found between said data representations are analyzed. The results of the analysis are provided.

### FIELD OF THE INVENTION

The present invention relates generally to the management of information technological (IT) networks, and for example, to computer-implemented methods, a computer program product and a computer system for providing remote support for a network infrastructure.

### BACKGROUND OF THE INVENTION

Nowadays, as information systems become ubiquitous and companies and organizations of all sectors become more and more dependent on their computing resources, the requirement for the availability of the hardware and software components of IT networks, and of services based on such networks, is increasing while the complexity of IT networks is growing. An IT network often comprises a diversity of devices, such as interconnect devices (routers, switches, hubs, etc.) and end devices (servers, workstations, PCs, printers, etc.). There is a desire to detect and to quickly rectify malfunctions of network devices and network connections. Since companies have the constant task of adapting the IT infrastructure to their daily needs, IT infrastructures are not static systems but are dynamically growing and changing. When network devices and connections are added, changed or removed, error sources are easily introduced and can often be found only with the help of IT specialists. Most hardware devices are equipped with software such as operating systems, middleware and applications. Wrong or outdated software versions or misconfigured software will generally cause malfunctions.

The management of a company's IT infrastructure can be outsourced to an external support service provider. Such a support service provider has usually restricted access to the IT infrastructure, and the customer can send information about the IT infrastructure to the support service provider via a network. The communication between the support service provider and the customer may use the Internet or a point-to-point connection (e.g. via an ISDN connection).

Remote support service for a customer's IT infrastructure is for example offered by Hewlett-Packard. In order to enable such remote support service, IT infrastructure management software provided by the service provider is installed within the customer's network. It collects information about the status of the customer's IT infrastructure. If a problem occurs in the customer's IT infrastructure the customer can ask the support service provider for support. After the support service provider has received the information collected, an expert analyzes it and tries to find the cause of the problem and to remedy it, either remotely or by sending a service engineer to the customer.

EP 1 118 952 A2 discloses a system for remote support service in which information about the IT network status and performance is collected, sent to and analyzed by a support service provider.

Typically, communication within the IT infrastructure, as well as between the IT infrastructure and the support service provider is based on the TCP/IP protocol suite (As to the meaning of the “TCP/IP protocol suite”, see e.g. W. Richard Stevens: TCP/IP Illustrated, Vol. 1, The Protocols, 1994, pages 1-2).

### SUMMARY OF THE INVENTION

A first aspect of the invention is directed to a computer implemented method of providing remote support for an IT infrastructure by a support service provider. The method according to the first aspect comprises the steps of: collecting within the IT infrastructure, information about the IT infrastructure so as to obtain a data representation of at least part of the IT infrastructure; transferring the data representation to the support service provider; comparing the data representation with at least one previously collected data representation so as to find differences between said data representations; analyzing the differences found between said data representations; and providing the results of the analysis.

According to another aspect, the invention is directed to a computer implemented method of providing remote support for an IT infrastructure by a support service provider. The method comprises the steps of: receiving a data representation of at least part of the IT infrastructure which was obtained by collecting information within the IT infrastructure; comparing the data representation with at least one previously received data representation so as to find differences between said data representations; analyzing the differences found between said data representations; and providing the results of the analysis.

According to a further aspect, the invention provides a computer program product including a program code for carrying out a method, when executed on a computer system, of providing remote support for an IT infrastructure by a support service provider. The computer code is arranged to: receive a data representation of at least part of the IT infrastructure which was obtained by collecting information within the IT infrastructure; compare the data representation with at least one previously received data representation so as to find differences between said representations; analyze the differences found between said data representations; and provide the results of the analysis.

According to a still further aspect, the invention provides a computer system for providing remote support for an IT infrastructure by a support service provider programmed such that it acts as having the following functional components: a receiving component for receiving a data representation of at least part of the IT infrastructure which was obtained by collecting information within the IT infrastructure; a comparing component for comparing the data representation with at least one previously received data representation so as to find differences between said data representations; an analysis component for analyzing the differences found between said data representations; and a providing component for providing the results of the analysis.

Other features are inherent in the methods, computer program product and computer system disclosed or will become apparent to those skilled in the art from the following detailed description of embodiments and its accompanying drawings.

### DESCRIPTION OF THE DRAWINGS

Embodiments of the invention will now be described, by way of example, and with reference to the accompanying drawings, in which:

FIG. 1 is a high-level diagram of a method as well as a system for providing a remote support service, including an IT infrastructure side;

FIG. 2 illustrates an exemplary IT infrastructure and its representation with a relational data model;

FIG. 3 shows two exemplary representations of a part of an IT infrastructure at the interface level;

FIG. 4 illustrates a difference algorithm;

FIG. 5 shows an exemplary difference list;

FIG. 6 is a high-level diagram illustrating how files linked to data sets are included in a comparison of two representations;

FIG. 7 is a flow diagram further illustrating the inclusion of files in a comparison of two representations;

FIG. 8 is a flow diagram of a rule-based analysis;

FIG. 9 illustrates an exemplary change report.

### DESCRIPTION OF THE PREFERRED EMBODIMENTS

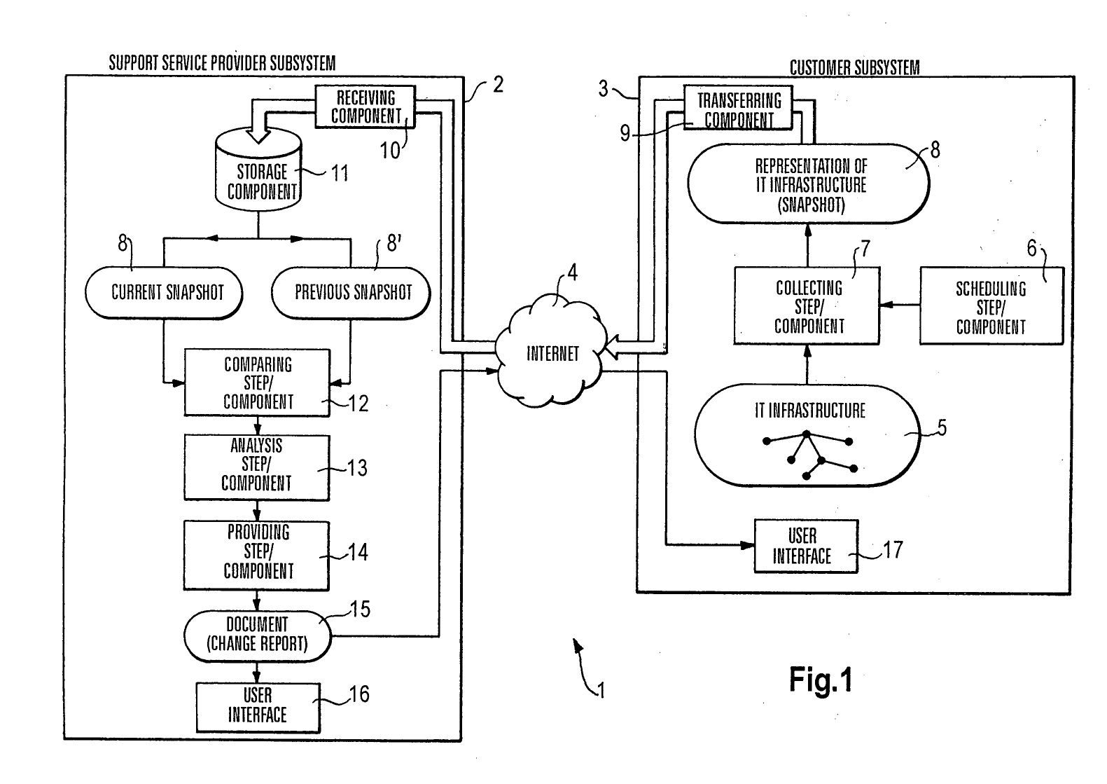

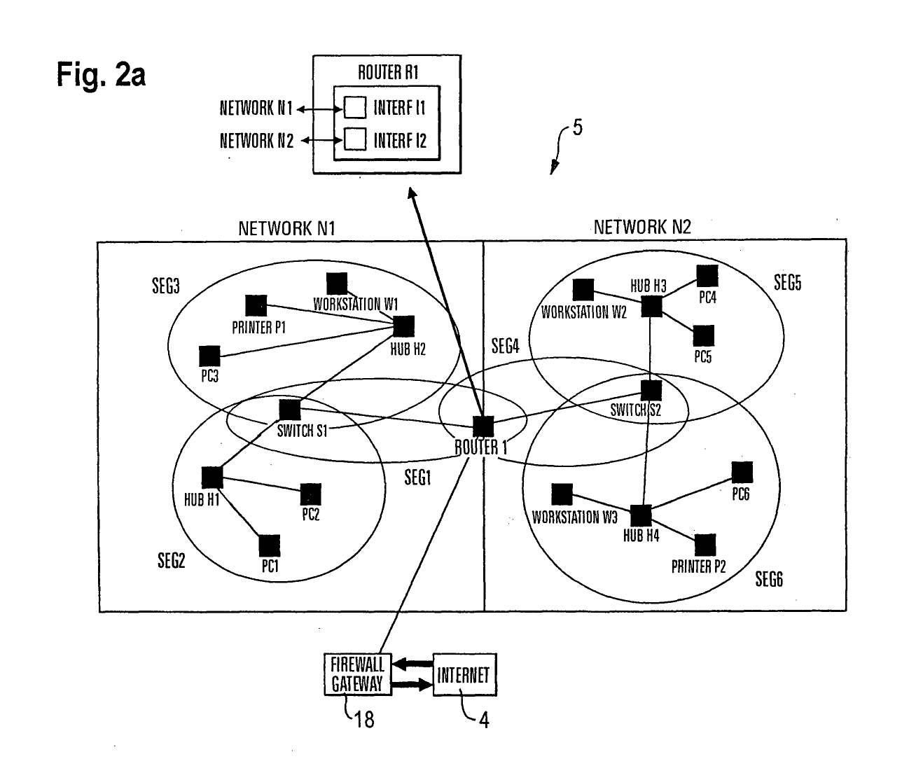

FIG. 1 shows a high-level diagram of an embodiment of a method and a system for providing a remote support service for an IT infrastructure. Before proceeding further with the description, however, a few items of the embodiments will be discussed.

In order to make the following description of the embodiments more comprehensible, the method and the computer system for providing a remote network support service are described in an “integrated” view, i.e. in a manner which includes both the method steps, programs and equipment of the support service provider's side and the IT infrastructure side, including the network connection between them. Usually, but not necessarily, the service provider and the IT infrastructure will belong to different organizations situated at distinct locations, so that it is appropriate to claim not only the overall method, but separately also that parts of the method, computer program product and computer system that are carried out or implemented at the service provider's side.

The embodiments of the method which are described now in more detail are directed to an automated supervision of the IT infrastructure without a manual initiation or intervention being required for the execution of the method.

The first step of the method concerns the IT infrastructure side, also called customer's side hereinafter. To find out the status and possible problems within the IT infrastructure, information about the IT infrastructure is obtained at the customer's side. In some of the embodiments, a collection software is permanently installed within the customer's IT infrastructure which runs as a background job in the customer's IT infrastructure and collects information about it. The collection software runs, for example, on a dedicated network management server in the customer's IT infrastructure. It may be assisted by a number of distributed “collection agents” which are installed on network elements to be managed, such as interconnect devices (e.g. routers, switches) and end devices (e.g. PC's, workstations, servers, printer, ect.) , and which communicate with the central software component on the network management server. Such collection software is known in the art and is, for example, described in EP 1 118 952 A2. The use of agents for the collection of network-element-related information is, for example, described in EP 1 244 251 A1. The collection software installed in the customer's IT infrastructure forms what is called the “collection component”.

The collection component preferably uses TCP/IP and other parts of the TCP/IP protocol suite (such as Ping, Traceroute and SNMP) to communicate with the network elements and to retrieve the required information from them. In some of the embodiments, the collection component is implemented so as to automatically detect changes in the IT infrastructure, such as the disappearance of IT infrastructure elements or connections of between them. To accomplish this, the collection component sends requests to known infrastructure elements, for example, by using Ping, Traceroute or SNMP (see Stevens, pages 85 to 110 and 359 to 388). In some of the embodiments, the collection component is not only able to discover the disappearance, but also the appearance of an element or a network connection. In order to discover yet unknown elements it can send trial echo requests (e.g. Ping requests) to possible IP addresses in a network. A new element with one of the IP addresses will respond to the respective echo request disclosing information about its identity. Further router-related information can be obtained from ARP caches or routing tables in routers, which can be accessed by the discovery system, for example by means of the Simple Network Management Protocol (SNMP). The discovery of switches (switches and bridges are commonly referred to as “switches” hereinafter) may be based on information, for example, hardware (MAC) addresses, stored in switches indicating to which other devices data frames have been forwarded in the recent past. This information may also be obtained by SNMP. Having confirmed the presence of known network elements and connections and identified new ones, configuration and/or performance information of the network elements is collected whereby changes of the IT infrastructure (besides disappearance and appearance of elements) are discovered.

In some of the embodiments the collecting step is automatically invoked by a scheduling component on a regular basis, say once per day. From the collected information a data representation of the IT infrastructure (or at least part of it) is built. The data representation is a “snapshot”, i.e. an instance of the represented network at a certain point of time.

In some of the embodiments the data representation of at least part of the IT infrastructure is realized on the basis of a relational data model (i.e. the data representations are instances of a relational data schema of the IT infrastructure). Such a relational data model is on the one hand, simple, and, on the other hand, well-suited to map the structure of an IT infrastructure, which is typically a hierarchical layer structure. For example, in some of the embodiments the customer's IT infrastructure is structured in the layers “network”, “segment”, “node” and “interface”. The IT infrastructure is subdivided into networks by routers. A network is, in turn, subdivided into segments by switches. A segment can also be defined as a “collision domain”, i.e. a domain in which data packets sent by different devices may collide with one another. A node is any type of interconnect or end device. An interface is a device by means of which node is connected to a network or segment, e.g. a network card of a router or a port of a switch. The hierarchical layer structure of the IT infrastructure is mapped to the relational data representation such that each layer is represented by at least one “relation” (usually visualized by a “table”), the data sets of which are the components of the respective layer (usually a data set is visualized by a line of the table). The connections between the IT infrastructure elements are represented by data set attributes which are pointers to the tables of the lower layers. Thus, the layer structure of the IT infrastructure is reflected in a corresponding layer structure of the data representation.

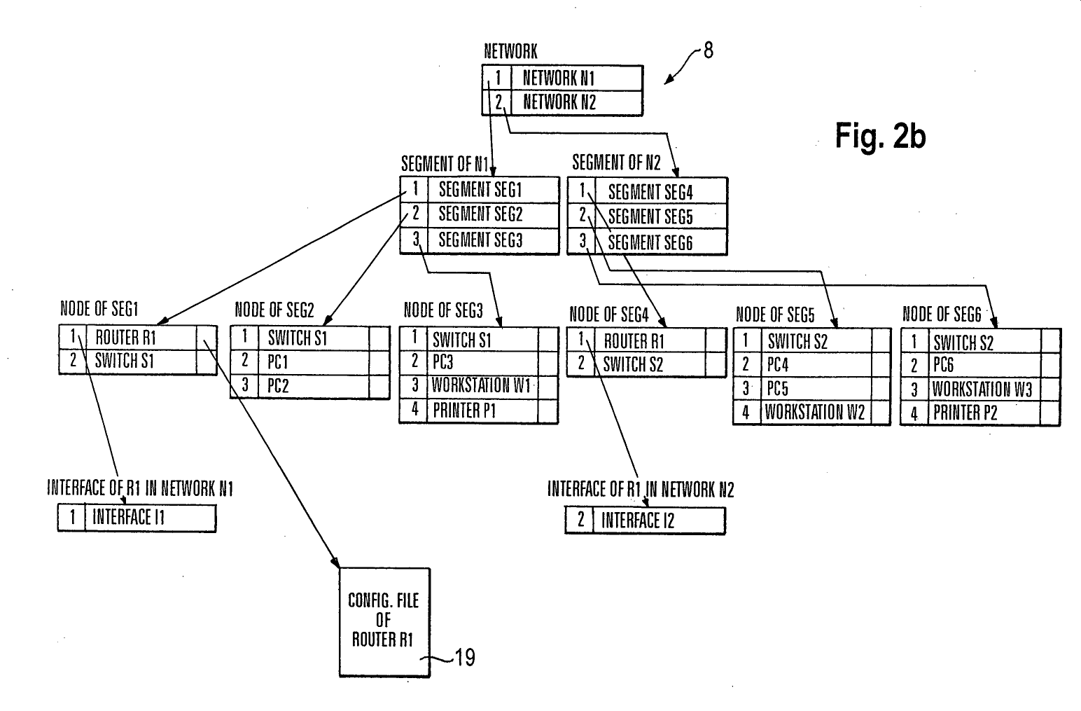

A complication arises from the fact that certain IT infrastructure elements may belong to more than one network or segment. For example, a router with two network interfaces (e.g. network cards) may belong to two different networks, wherein one network interface is connected to the first network, and the other one is connected to the second network. Such more complicated structures can also be represented by the relational data model. In the above example, one and the same router appears twice in the representation, first as a data set in the node table of the first network and, second, as another data set of the node table of the second network. The data set of the router in the node table of the first network contains a reference to an interface table in which the first network interface appears as a data set, whereas the data set of the same router in the node table of the second network contains a reference to another interface table in which the second interface card appears as a data set. The topology of an IT infrastructure can be reconstructed from such a representation by visiting all elements of the representation and noticing that certain elements appear more than once in different tables (such as the router in the above example). In another example shown in FIG. 2, a router R1 appears three times since it has three network interfaces in three different networks.

In some of the embodiments, the data model further includes references (pointers) which are preferably assigned to IT infrastructure elements (e.g. at the node or interface level) and which reference files which include IT-infrastructure-element-related information. In some of the embodiments, these files are configuration files (which include configuration information of the respective element), performance files (which include performance and health information of the respective element, such as the fraction of remaining free space of a data storage system), and/or files including software version information, etc. The referenced files are part of the “snapshot” and are generally stored together with the relational tables and transmitted together with them to the support service provider, as is explained below.

Besides the data representing the IT infrastructure, a snapshot comprises a collection-related data which distinguishes the snapshot from other snapshots and enables to determine whether the snapshot was collected before or after another one. This data comprises, for example, an identifying number incremented with each collection cycle and/or a date and time indication of when the collection took place, both commonly referred to as “collection-ID”. The collection-ID is generated and associated with the collected infrastructure data in the collection step. The associated data forms the snapshot.

In some of the embodiments, the IT infrastructure and the support service provider are located at different sites referred to as IT infrastructure site (or customer site) and support service provider site. The snapshot representations of the IT infrastructure (including the collection-ID and referenced files) are transferred from the IT infrastructure site to the support service provider site via a network, for example, the Internet or a point-to-point connection (e.g. via ISDN) . Preferably, a snapshot is not only transferred after a problem has occurred at the customer site. Rather, the snapshots are regularly transferred, for example, immediately after their generation, or on a scheduled basis. This enables potential or already existing problems to be detected in an early phase, even before they are noticed at the customer site or have any impact (such as a failure) in the customer's IT infrastructure. Optionally, the same or another network connection enables the support service provider to have access to the IT infrastructure for the execution of active network management steps at the customer site. In some of the embodiments, the data including the snapshots is transferred via the Internet, while a point-to-point-connection is used by the service provider in order to intervene in the customer's IT infrastructure. Those parts of the computer systems and software which are responsible for the data transfer are called the “transferring component” and the “receiving component”.

In some of the embodiments, when a snapshot (including the collection-ID and referenced files) is received at the support service provider site for further processing, it is first stored in a storage system at the support service provider site. Since subsequent analysis steps are based on a comparison of two snapshots representing the IT infrastructure at different points of time, at least two different snapshots are kept in the storage system at the service provider site (or, in alternative embodiments at the customer site). Since generally, the current status of the IT infrastructure is of most interest, at least the two most recent snapshots are stored. In order to enable a more reliable and/or refined analysis, more than two snapshots, e.g. the five most recent snapshots can be stored. When a new snapshot is received and stored, the older snapshot (or the oldest one, in the case of more than two stored snapshots) is removed from the storage system.

The analysis of the IT infrastructure carried out at the support service provider site starts out with a determination of differences between two different snapshots, typically the ultimate and the penultimate snapshots. As a result of such a difference operation, information is obtained about disappearance, changes, and appearance of network elements and connections, as well as information about configuration and performance changes, all of which have occurred between the two points of time to which the two snapshots refer. As explained above, the snapshots are instances of a relational data model in some of the embodiments, i.e. they are in the form of tables. The difference between two such relational data representations is determined by means of a difference algorithm. In some of the embodiments, the difference algorithm comprises two passes over corresponding tables of the representations to be compared. In the first pass, for each data set of the tables of a first snapshot (which is e.g. the older one of the snapshots to be compared), all data sets of the second snapshot are visited in order to find out whether a data set corresponding to the data set of the first snapshot is present in identical or changed form in the second snapshot. During this first pass, data sets which have disappeared or have been changed between the collection times of the first and second snapshots are identified. In order to also identify the appearance of data sets, a second pass is carried out in which, for each data set of the second snapshot (which, in this example, is the younger one of the two snapshots to be compared), all data sets of the first snapshot are visited in order to find out whether a data set corresponding to the data set of the second snapshot is present in the first snapshot. As a result of the second pass, all data sets which have appeared between the collection times of the first and second snapshots are identified. In a subsequent consolidation step, the results of the two passes are consolidated, i.e. merged to a combined result which indicates, besides all unchanged data sets, all disappearances, appearances and changes which occurred between the collection times of the two snapshots. Finally, after having compared the tables of the relational data representations, the information contained in files referenced by data sets (such as configuration files, performance files etc.) of the two snapshots are also compared for corresponding data sets, in order to identify configuration changes, performance changes and the like. The result of the comparing steps are one or more “difference lists”. In some of the disclosed embodiments, the comparing step is automatically initiated, as soon as a new snapshot is received (provided, of course, that the support service provider's currently available computing resources have the capacity to perform this task). The installed software which is responsible for carrying out the comparing step is called the “comparing component”.

In a following analysis step, the differences between the two snapshots found in the previous comparing step are analyzed. The analysis judges whether a difference identified is indicative of present or future functional behavior of the IT infrastructure. The main issue of the analysis is to evaluate the relevance or severity of a difference between two snapshots which was found in the previous comparing step. What is considered as “relevant” or “severe” generally depends on the particular tasks and functions to be fulfilled by the customer's IT infrastructure. For example, possible relevance criteria could be an impact on present or future operability, performance, availability and/or security of the IT infrastructure. Some events detected in the previous comparing step may be of only minor relevance for the operability of the IT infrastructure (such as the appearance of a printer), may be of medium relevance (such as the disappearance of a printer), or of major relevance (such as the failure of a router). Sorhe incidents may have an impact on the present functional behavior of the IT infrastructure (such as the disappearance of a router), whereas other incidents may only have an impact on its future functional behavior (for example, if it is found that a the configuration of a router has been changed, but the changed configuration has not been stored in the router (e.g. in its configuration file), so that the old configuration rather than the new one will be loaded when the router is re-booted). In some of the embodiments, the obtained evaluated differences of the two compared snapshots are categorized according to the relevance or severity of the impact indicated by them. For example, the three events mentioned above are assigned to three different severity categories, such as “low impact changes”, “medium impact changes” and “critical impact changes”. In some of the embodiments, the analysis is based on predefined rules. The rules are preferably not hard-coded, but can be input by an operator without recompiling and re-loading the analysis program by means of a scripting language, e.g. Perl scripts on Unix/Linux. The analysis of the differences between two snapshots is automatically initiated, e.g. as soon as the previous comparing step has been completed. The installed software which carries out the analysis step is called the “analysis component”.

Finally, the results of the analysis are provided. For example, they are manifested in a human-readable or computer-readable form, e.g. in the form of a document (a “change report”) to an operator at the support service provider site and/or to the customer. The document may be in the form of a text processor document, a markup-language document or a spread sheet which can be sent to the operator and/or the customer in electronic form via e-mail or telefax or printed out and provided to the operator and/or sent to the customer as a paper document. Alternatively, the document may be of any other suitable electronic or paper document type and any other type of dispatch to the customer may be used, including the possibility that the operator and/or the customer can fetch the document over the Internet or another network. In certain cases an automatic action may be taken in response to the analysis result. If it is; for example, found that a certain process which is required to run in the IT infrastructure is not running (or a process which should not run is running), the process may be automatically started or deleted, without human intervention. For such cases, the analysis result may be manifested in a computer-readable form, e.g. in the form of an XML document, sent to the customer and processed there so as to automatically initiate the required action. The providing step also is automatically initiated, preferably as soon as the previous analysis step is terminated. The installed software which is arranged for providing the analysis results is called the “providing component”.

The preferred embodiments of the computer program product include any machine-readable medium that is capable of storing or encoding program code for execution by a computer or computer system and that causes the computer or computer system to perform any of the methodologies of the embodiments. The term “machine-readable medium” shall accordingly be taken to include, but not to be limited to, solid state memories, optical and magnetic disks, and carrier wave signals. The database software used on the service provider site is preferably based on a commercially available database, for example, Microsoft SQL 2000. The program which, when executed, carries out one of the embodiments of-the support service on the service provider site can be implemented in a usual high-level programming language (such as Java) or in a specialized query language (such as SQL).

The computer system used on the support service provider's site is preferably a commercially available server, workstation or PC which preferably uses the Unix/Linux or Windows operation systems. The customer's IT infrastructure is usually made up of commercially available end devices (servers, workstations, PCs, printers etc.) and interconnect devices (routers, switches, etc.) and conventional network connections, and is based on the TCP/IP protocol suite. The connection between the customer and the network service provider site is an Internet connection (e.g. used for the transfer of the snapshot form the customer to the service provider site and the change reports in the reverse direction) and/or a point-to-point connection (e.g. used for interventions by the service provider into the customer's IT-infrastructure), also based on the TCP/IP protocol suite.

Returning now to FIG. 1, which shows a high-level diagram of an embodiment of a method for providing a remote support service for an IT infrastructure. FIG. 1 simultaneously is a high-level architecture diagram of a system 1 for providing the desired remote service. In FIG. 1, the term “step” refers to the method, whereas the term “component” refers to the system 1. The system 1 can be subdivided in three parts: (i) a support service provider subsystem 2 (which is an embodiment of the “computer system for providing remote support for an IT infrastructure by a support service provider”), a customer subsystem 3 and a network connection 4 linking the two subsystems 2 and 3, here the Internet. The IT infrastructure 5 for which support is to be provided is part of the customer subsystem 3. It comprises network elements or “nodes” such as routers, switches, hubs, servers, work stations, PCs, I/O devices, such as printers, etc.

The IT infrastructure 5 comprises a infrastructure management server which is programmed such that, inter alia, it has a scheduling component 6 and a collection component 7. In FIG. 1 these components 6 and 7 are shown to be separate from the IT infrastructure 5 since they contribute to its management, although they can actually be part of the IT infrastructure 5. The scheduling component 6 is permanently active as a background job and controls the start of a “collection” by automatically invoking the collection component at predefined points of time, e.g. periodically. For example, the collection component 7 is triggered every day at a particular time. In addition, the collection component 7 can also be invoked by manual intervention of an operator.

Upon invocation, the collection component 7 carries out the collecting step. As already explained above, it sends requests to known elements of the IT infrastructure 5 so as to confirm that these elements and their network connections are still available, and collects status information from them. The collection component also detects new elements of the IT infrastructure 5 and collects information from them. It then generates a data representation 8 of the IT infrastructure 5, using the obtained information. The data representation 8 represents the status of the IT infrastructure 5 at the collecting time and can therefore be considered as a “snapshot” of the IT infrastructure 5. The collection component 7 also includes collection-related data in the snapshot 8, in particular a connection-ID which includes an identifying number and an indication of the collecting date and time and enables the present snapshot 8 to be distinguished from other snapshots and to determine the sequence in which several available snapshots were taken.

Then, a transferring component 9 transfers the snapshot via the connection 4 to the support service provider subsystem 2, where it is received by a corresponding receiving component 10. The transfer is automatically initiated as soon as the snapshot 8 has been generated by the collection component 7.

After the transfer step, the snapshot 8 is stored in a storage component 11 which is part of the support service provider subsystem 2. The storage component 11 stores at least two snapshots, e.g. the current snapshot 8 and the previously received snapshot 8′. In other embodiments more than two, e.g. five snapshots are stored, for example, the current snapshot and the four previously received snapshots. When a new snapshot 8 is stored, the oldest of the stored snapshots is removed from storage so as to prevent the number of stored snapshots from increasing.

The different snapshot versions and their chronological order are identified by means of the collection-ID. Based thereupon, the current snapshot 8 and the previous snapshot 8′ are then read out from the storage component 11, and a comparing step is carried out by a comparing component 12. The comparing component 12 is automatically invoked each time a new snapshot 8 has been received and stored. In the comparing step, a difference algorithm is carried out which provides the differences between the compared snapshots 8 and 8′.

When the comparing step 12 has been completed, an analysis component 13 is invoked and carries out an analysis step. In this analysis step, the differences found in the previous comparing step are analyzed as to whether they are indicative of problems within the IT infrastructure 5.

When the analysis step has been finished, a providing component 14 is invoked which carries out a providing step. It provides the result of the analysis step, a document or “change report” 15 to a user interface 16 where a support service expert can inspect the document's content. In addition, the document 15 is sent via e-mail over the Internet 4 to a user interface 17 at the customer subsystem 3.

FIG. 2 schematically illustrates an example of the IT infrastructure 5 (FIG. 2a) and its representation with a relational data model (FIG. 2b). The IT infrastructure 5 comprises two networks, N1 and N2, separated by a router R1. Network N1 is subdivided by a switch S1 in three segments, SEG1, SEG2 and SEG3; and network N2 is subdivided by a switch S2 in three segments, SEG4, SEG5 and SEG6. The segments SEG1 and SEG4 connect the router R1 with the switches S1 and S2, respectively. The segments SEG2, SEG3, SEG5, SEG6 comprise hubs Hi, H2, H3, H4 and end devices, such as workstations W1, W2, W3, personal computers PC1, PC2, PC3, PC4, PC5, PC6 and printers P1, P2. The router R1 has two interfaces (e.g. network cards) 11, 12, one interface for each network N1, N2. The interfaces 11, 12 and their assignment to the networks N1, N2 are shown in an enlarged cut-out above FIG. 2a. The router R1 also has a connection to a firewall gateway 18 which, in turn, is connected to the Internet 4. (For simplicity, the router's interface to the Internet 4 via the firewall gateway 18 is not shown in the enlarged cutout of FIG. 2a).

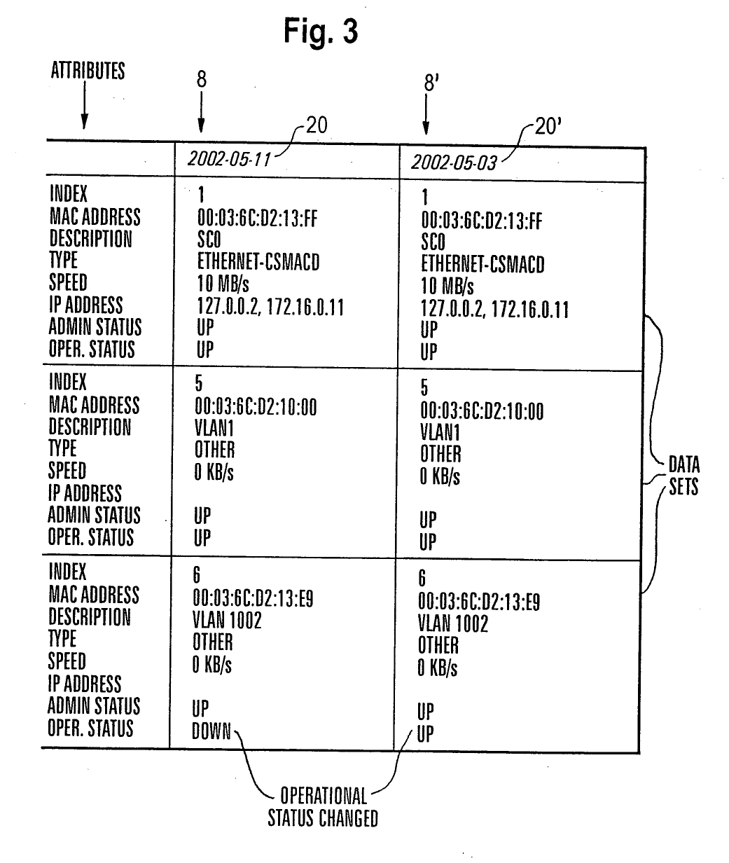

The tables shown in FIG. 2b illustrate an embodiment of a representation of the IT infrastructure 5 of FIG. 2a according to a relational data model. The tables have a number of attributes which, for simplicity, are not shown in FIG. 2b, but, for example, in FIG. 3. The representation has a hierarchical structure of tables with four layers: “Network”, “Segment”, “Node” and “Interface”. The relations between data sets and tables of a lower layer are indicated by arrows in FIG. 2b. At the highest level, there is one network table which represents the root of a tree-like table structure. The network table has two data sets which represent the two networks N1 and N2. Each of the data sets N1 and N2 points to one table of the segment layer, named “Segment of N1” and “Segment of N2”. The segment tables have three data sets representing the segments SEG1, SEG2, SEG3 of network N1 and SEG4, SEG5, SEG6 of network N2, respectively. Each data set of the segment layer points to a table of the next lower layer, the node layer. Consequently, there are six node tables, “Node of SEG1” to .“Node of SEG6”. Each node, i.e. each router, switch and end device (e.g. workstation, PC, printer), is represented by a data set in the node table of that segment to which the node belongs. However, hubs are not represented since they are typically unmanaged and behave like parallel cable connections between the nodes of a segment and are transparent (i.e. invisible) for typical discovery programs. In other embodiments hubs may also be discovered and managed (for example, each hub may then have a management agent) and therefore appear in the representation of the IT infrastructure (e.g. in the node table). The router R1 belongs to both networks N1 and N2, and is therefore represented twice, once by a data set in each of the Node of SEGL and Node of SEG4 tables. However, the two data sets of the router R1 each point to a different interface table, “Interface of R1 in N1” and “Interface of R1 in N2”. Each of these interface tables has one data set which represents that interface which belongs to the corresponding network N1 or N2. (The interface of router R1 to the firewall gateway 18 is not shown). Interface of switches lying in different segments are represented in an analogous manner. This technique of assigning multiple data sets to a router which belongs to more than one network (such as router R1) or to a switch which belongs to more than one segment and associating with each of these multiple data sets only that interface which belongs to the respective network or segment enables complicated network structures (which may even include circles) to be mapped to a simple hierarchical relational data structure, without loss of information. Therefore, the structure of the IT infrastructure 5 illustrated in FIG. 2a can be reconstructed from the relational data representation of FIG. 2b (apart from the hubs which are not included in the representation of FIG. 2b).

Furthermore, the relational data representation of FIG. 2b includes links from data sets of node tables (and, optionally, interface tables) to files which contain further information about the respective nodes or interfaces, for example configuration files 19 (for simplicity, in FIG. 2b only the router R1 shown to have a pointer to a configuration file 19). The configuration files 19 are part of the snapshot 8 and are transmitted to the support service provider subsystem and stored in the storage component 11 together with the tables of the relational data model.

Another embodiment of a relational-data-model representation of the IT infrastructure 5 of FIG. 2a is illustrated by tables shown below. In contrast to the tree-like representation of FIG. 2b, all data sets of one layer are included in one common table per layer. The relations between data sets at different layers are represented by attributes of the tables. In such a representation with only one common table per layer the number of tables does not depend on the given actual infrastructure configuration (which often changes in a typical IT infrastructure). Therefore, such a representation with a fixed number of tables (e.g. one table) per layer is less “dynamic” and easier to handle than the tree-like representation of FIG. 2b.

In the exemplary network table the networks are identified by a NetworkID. The table has the attributes “SnapshotID” (explained below), “Name” and “Description”:

Network table

| NetworkID | SnapshotID | Name | Description |
|---|---|---|---|
| 1 | 1134 | N1 | Network 1 |
| 2 | 1134 | N2 | Network 2 |

In the exemplary segment table the segments are identified by a SegmentID. The table has the additional attribute “NetworkID” so as to include the relation between the segment and the network layers:

Segment table

| SegmentID | NetworkID | SnapshotID | Name | Description |
|---|---|---|---|---|
| 1 | 1 | 1134 | SEG1 | Segment 1 |
| 2 | 1 | 1134 | SEG2 | Segment 2 |
| 3 | 1 | 1134 | SEG3 | Segment 3 |
| 4 | 2 | 1134 | SEG4 | Segment 4 |
| 5 | 2 | 1134 | SEG5 | Segment 5 |
| 6 | 2 | 1134 | SEG6 | Segment 6 |

In the exemplary node table the nodes are identified by a NodeID. The table has the additional attribute “SegmentID” so as to include the relation between the node and the segment layers:

Node table

| NodeID | SegmentID | SnapshotID | Name | Description |
|---|---|---|---|---|
| 1 | 1 | 1134 | R1 | Router |
| 2 | 1 | 1134 | S1 | Switch |
| 3 | 2 | 1134 | S1 | Switch |
| 4 | 2 | 1134 | PC1 | Personal |
| | | | | Computer |
| 5 | 2 | 1134 | PC2 | Personal |
| | | | | Computer |
| 6 | 3 | 1134 | S1 | Switch |
| 7 | 3 | 1134 | PC3 | Personal |
| | | | | Computer |
| 8 | 3 | 1134 | W1 | Workstation |
| 9 | 3 | 1134 | P1 | Printer |
| 10 | 4 | 1134 | R1 | Router |
| 11 | 4 | 1134 | S2 | Switch |
| 12 | 5 | 1134 | S2 | Switch |
| 13 | 5 | 1134 | PC4 | Personal |
| | | | | Computer |
| 14 | 5 | 1134 | PC5 | Personal |
| | | | | Computer |
| 15 | 5 | 1134 | W2 | Workstation |
| 16 | 6 | 1134 | S2 | Switch |
| 17 | 6 | 1134 | PC6 | Personal |
| | | | | Computer |
| 18 | 6 | 1134 | W3 | Workstation |
| 19 | 6 | 1134 | P2 | Printer |

In the exemplary interface table the interfaces are identified by an InterfaceID. The table has the additional attribute “NodeID” so as to include the relation between the interface and the node layers. The fact that there are more than one data set for one and the same node (here two data sets for the node with NodeID=1) enables the structure of the IT infrastructure 5 illustrated in FIG. 2a to be reconstructed from the relational data representation, as explained in connection with of FIG. 2b:

Interface table

| InterfaceID | NodeID | SnapshotID | Name | Description |
|---|---|---|---|---|
| 1 | 1 | 1134 | I1 | Interface 1 |
| 2 | 1 | 1134 | I2 | Interface 2 |

FIG. 3 shows an example of a current snapshot 8 and a previous snapshot 8′ at the interface level. It includes typical output from switch interfaces. A collection-ID 20, 20′ specifies the date on which the collecting step was performed (in this example “2002-05-11” and “2002-05-03”). It enables the two snapshots 8, 8′ to be distinguished. The shown interface tables each have three data sets with eight attributes (In FIG. 3, the attributes are listed one below the other rather than side by side, as in FIG. 2a). One of the attributes is the “operational status”. As can be seen in FIG. 3, the operational status of the interface “index 6” has changed from “up” to “down”. The difference algorithm which will be described below not only discovers the appearance and disappearance of elements, but also changes of attributes, as the one illustrated in FIG. 3.

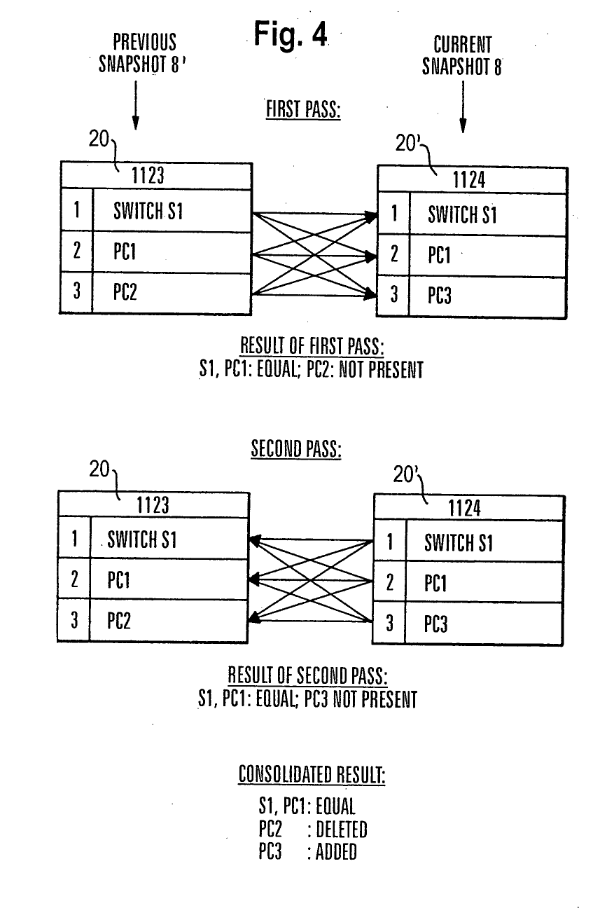

FIG. 4 illustrates an embodiment of a difference algorithm. A current snapshot 8 and a previous snapshot 8′ are compared with each other. For simplicity, only node tables with only one attribute and three data sets, corresponding to segment SEG 2 of FIG. 2a, are shown. In the example of FIG. 4, the collection-ID 20, 20′ is an identifying number which is incremented by one in consecutive snapshots (in this example “1123” and “1124”). The differences between the snapshots 8, 8′ are determined in two passes. In the first pass, for each data set of the previous snapshot 8′ all data sets of the current snapshot 8 are visited and it is determined whether for the current data set of the previous snapshot 8′ a corresponding data set is present in the current snapshot 8 and whether the corresponding data sets are equal in all their attributes, as indicated by bundles of arrows in FIG. 4. (Of course, if a corresponding data set has been found in the current snapshot 8, there is no need to visit its remaining data sets, and the processing can continue with the next data set of the previous snapshot 8′). As a result of the first pass, it is found that the data set “PC2” of the previous snapshot 8′ is not present in the current snapshot 8. The fact that a new data set (“PC3”) is present in the current snapshot 8 is not found during the first pass. Then, the second pass is carried out. Now, the above-described determination is repeated in the reversed time direction, i.e. for each data set of the current snapshot 8 all data sets of the previous snapshot 8′ are visited and the determination described above is carried out for them. As a result of the second pass it is found out that the data set “PC3” which is present in the current snapshot 8 is not present in the previous snapshot 8′. In a consolidation step it is concluded that “switch S1” and “PC1” have remained equal, “PC2” has disappeared and “PC3” has appeared in the time interval between the collection of the previous and the current snapshots.

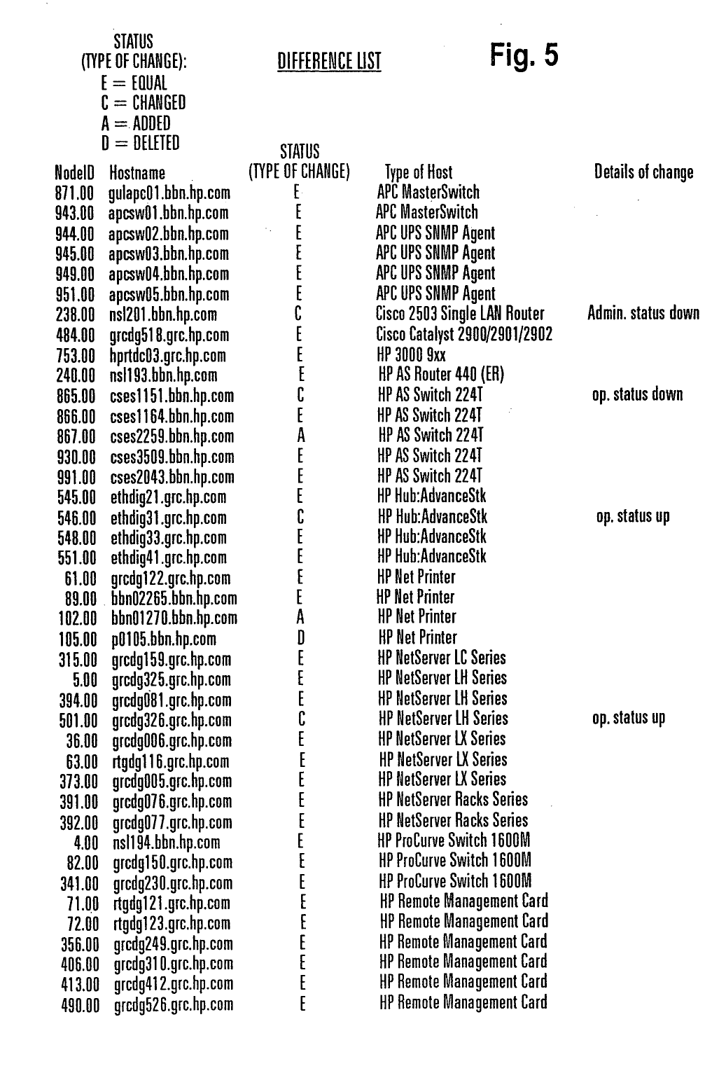

FIG. 5 illustrates a difference list which is the output of the abovedescribed difference algorithm, however for another embodiment of an IT infrastructure 5. The list has five attributes “NodeID”, “Hostname”, “Status”, “Type of host” and “Details of change”. The status (i.e. type-of-change) attribute can take the following values: A added (appeared), C changed, D=deleted (disappeared) and E=equal. Data sets with the “equal” attribute can, in principle, be omitted. However, their inclusion in the difference list is useful in such embodiments in which, in a further step, also files linked to data sets are compared, since such a comparison will also include data sets with the “equal” attribute.

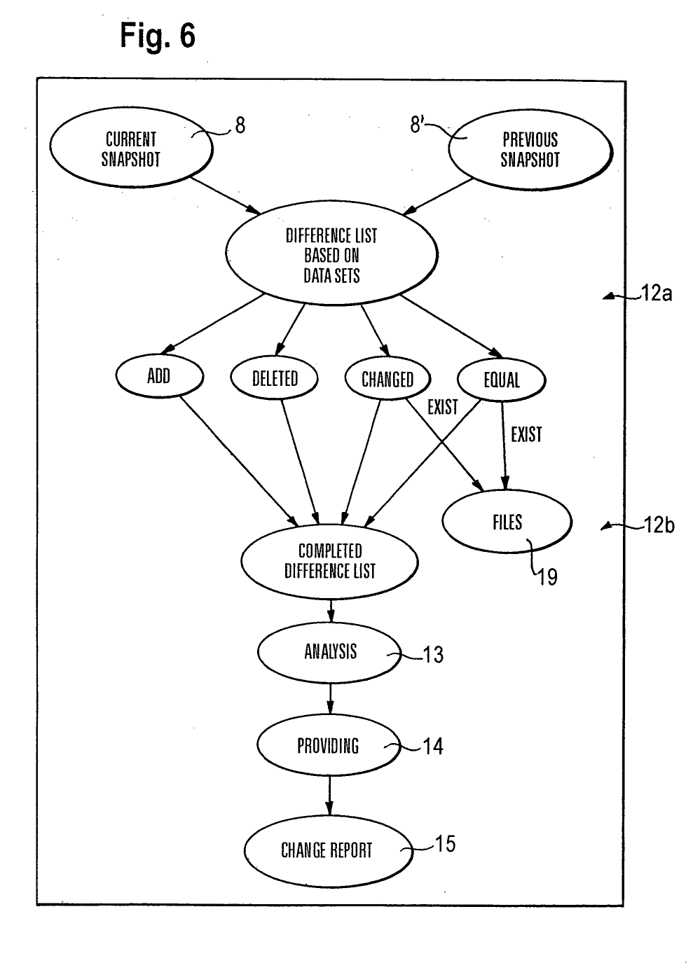

FIG. 6 is a high-level diagram illustrating how the information contained in files 19 linked to data sets is included in the comparison and analysis steps. As already explained above, a current snapshot 8 and a previous snapshot 8′ are compared. In a first step of this comparison, denoted by “12a” the difference between the relational representations (or tables) of these snapshots is determined, as explained in connection with FIGS. 3-5. As the result of step 12a, one of the attributes “added”, “deleted”, “changed” and “equal” is assigned to each data set of the compared snapshots 8, 8′. For data sets with the attributes “added” and “deleted”, the comparing step is then finished so that their entries in the difference list can be used in the subsequent analysis step 13 without further processing. However, for data sets with the attributes “changed” and “equal”, the comparison between the current snapshot 8 and the previous snapshot 8′ also includes files 19 which are optionally linked to data sets on the node level. If a data set has no such files 19 both in the current snapshot 8 and the previous snapshot 8′, the respective entry in the difference list can be used in the subsequent analysis step 13 without further processing. However, if one or more files 19 are linked to the data set under consideration, the files 19 are compared with each other in a file comparing step 12b. As the result of step 12b, differences between corresponding files 19 of the compared snapshots 8, 8′ are determined. For example, if the compared files 19 are configuration files, a configuration change of an associated node or interface which has occurred between the collection times of the compared snapshots 8, 8′ is detected. The results of the file comparing step 12b are included as an additional attribute in the difference list illustrated in FIG. 4 and, optionally, the status attribute can be changed from “equal” to “changed”, if a change has been detected in the files 19 of a pair of data sets which originally had the “equal” attribute. The resulting difference list is denoted as “Completed difference list” in FIG. 6. Then, subsequent analysis step 13 is invoked, which bases its analysis on the completed difference list. Finally, as a result of the subsequent providing step 14, document 15, i.e. the “change report” is printed out or electronically sent to user interfaces 1 6, 17 at the support service provider site 2 and/or the customer site 3, e.g. as an Microsoft Word or Microsoft Excel file.

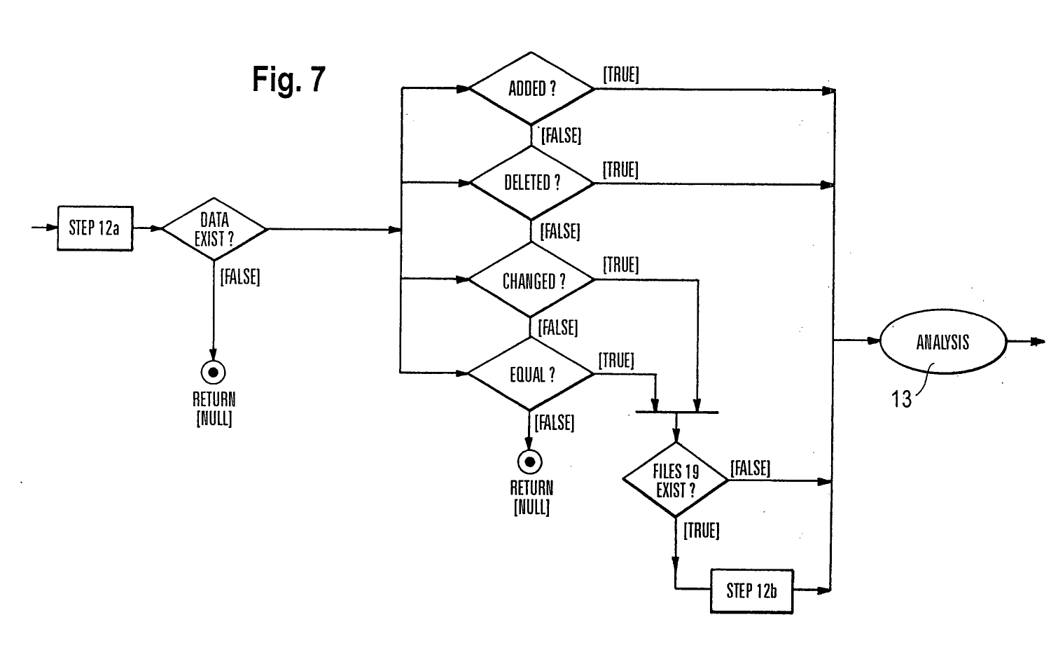

FIG. 7 is a flow diagram which further illustrates the processing of data sets in the file comparing step 12b in dependence on the different attributes, the functional aspect of which has already been explained in connection with FIG. 6.

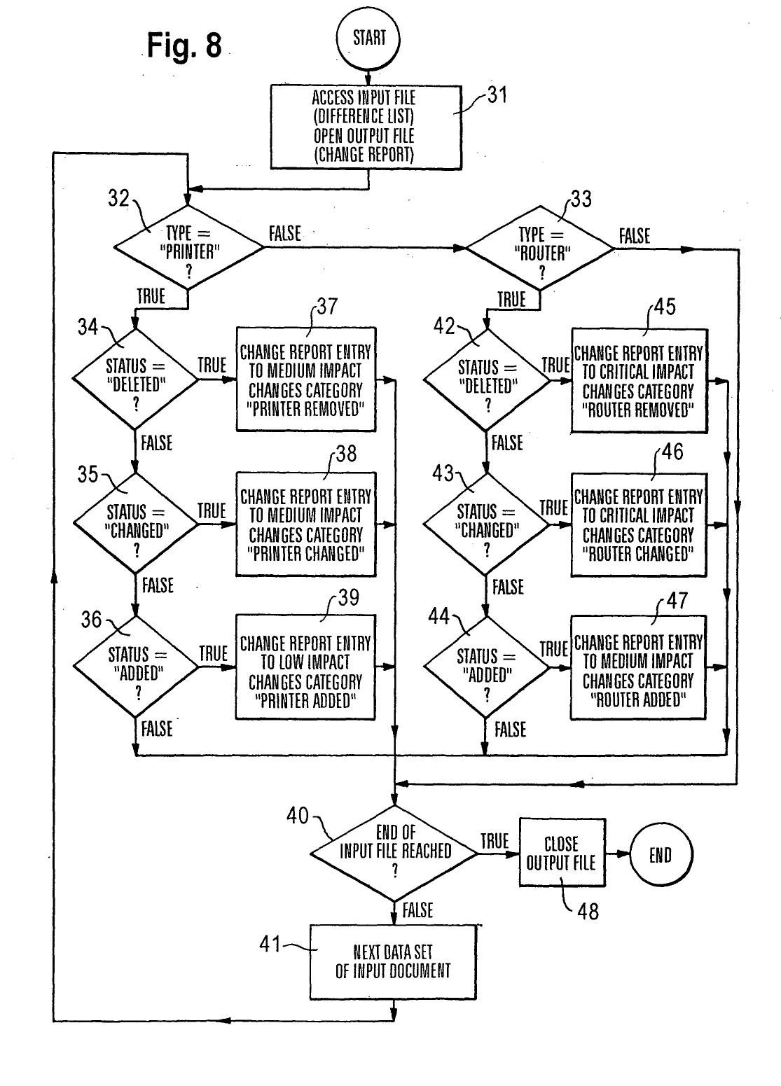

FIG. 8 shows a simplified example of a rule-based analysis carried out on a result (a “difference list”) of the comparing step 12. The analysis mainly categorizes differences between two snapshots found in the comparing step in several categories of different severity. In the example of FIG. 8, there are three such categories, called “critical impact changes”, “medium impact changes” and “low impact changes”. The analysis is based on rules which are not hard-coded in the analysis program, but can be defined by an operator in the form of script commands (e.g. Perl scripts).

In step 31, the input file (a difference list) is accessed and an output file (into which a “change report” is written) is opened. The process starts with the first data set of the input file. In step 32 it is ascertained whether the “type” of the node of the present data set is a “printer”. If the answer is negative, it is ascertained in step 33 whether the type is a “router”. If the answer is negative, the next data set is processed. (in other words, according to the simplified example illustrated in FIG. 8, there are only two types, “printer” and “router”).

If the answer to the query in step 32 is positive, it is ascertained in steps 34, 35 and 36 whether the status of the printer is “deleted”, “changed” or “added”. If the answer to one of these queries is positive, a corresponding entry is added in steps 37, 38 or 39 to the output document in one of three severity categories of the output document according to corresponding assignments specified in steps 37 to 39. In particular, since the disappearance or a change of a printer are considered as changes of medium impact, an entry which identifies the printer and has the description “printer removed” or “printer changed” is added to the “medium impact” category of the output document in steps 37 or 38. In some of the embodiments, a more detailed description of what has changed is added to the output document in step 38. In still further embodiments, the assignment to a certain category is based on the type of change which has occurred, since certain changes will generally be more severe than other changes. If the status is “added”, an entry is added to the low impact category of the output document, together with the description “printer added”, in step 39. If the status is “equal”, nothing is written to the output document. Then, provided that the end of the input document has not yet been reached (step 40), the next data set of the input document is read (step 41) and the flow returns to step 32.

If the answer in step 32 is negative and the answer in step 33 is positive (i.e. if the type of the node is “router”), it is ascertained in steps 42, 43 and 44 whether the router's status is “deleted”, “changed” or “added”, similarly to steps 34 to 36. If the answer to one of these queries is positive, a corresponding entry is added to the output document in steps 45 to 47, similarly to steps 37 to 39. However, since a router is more important than a printer, changes of the router are considered as more serious than those of the printer. Therefore, the status attributes “deleted” and “changed” lead to entries in the “critical impact changes” category (steps 45 and 46), and the status “new” leads to an entry in the “medium impact changes” category. The flow then returns through steps 40 and 41 to step 32. When the last data set of the input document is reached (step 40), the output file is closed (step 48) and the analysis 13 is terminated. The rules defining the analysis, i.e. the queries in steps 32-36 and the assignments in steps 37-39 and 45-47 can be user-defined by scripts.

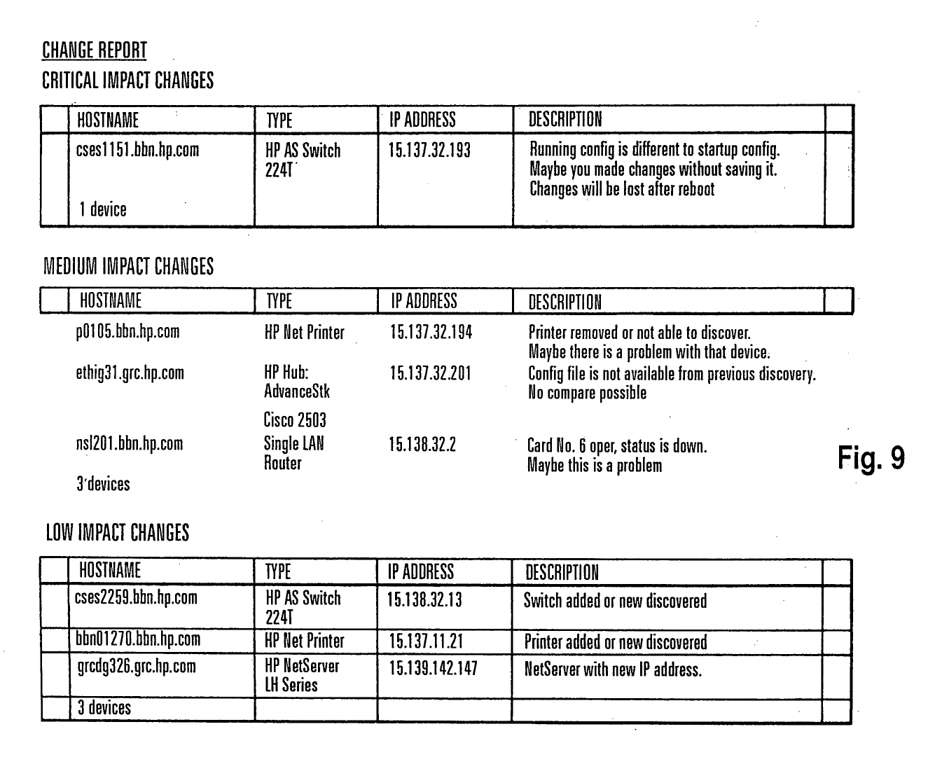

FIG. 9 illustrates an example of a result of the analysis step 13, an output document or “change report”. The change report includes the three severity categories which have already been mentioned in connection with FIG. 8. In each category, those infrastructure elements are listed which show a problem falling within the respective category. For each of the listed network elements, several attributes are specified, such as “host name”, “type”, “IP address” and “description”. The output document is finally provided in step 14 to user interfaces 16, 17 at the support service provider and/or the customer, e.g. automatically sent to the customer via e-mail.

The preferred embodiments enable a “proactive” remote management of a customer's IT infrastructure which means that problems and faults in the IT infrastructure can automatically be detected, before they cause any trouble in the customer's IT infrastructure and even before they are noticed by the customer. Change reports can be automatically and regularly sent to the customer.

All publications and existing systems mentioned in this specification are herein incorporated by reference.

Although certain methods and products constructed in accordance with the teachings of the invention have been described herein, the scope of coverage of this patent is not limited thereto. On the contrary, this patent covers all embodiments of the teachings of the invention fairly falling within the scope of the appended claims either literally or under the doctrine of equivalents.

What is claimed is:

1. A computer implemented method of providing remote support for an IT infrastructure by a support service provider, comprising the steps of:
collecting within the IT infrastructure information about the IT infrastructure so as to obtain a data representation of at least part of the IT infrastructure;
transferring the data representation to the support service provider;
comparing the data representation with at least one previously collected data representation so as to find differences between said data representations;
analyzing the differences found between said data representations;
providing the results of the analysis.

2. The method of claim 1, wherein the method is automatically initiated.

3. The method of claim 1, wherein the collecting step comprises automatically detecting the appearance, disappearance or changes of IT infrastructure elements.

4. The method of claim 1, wherein the data representation of at least part of the IT infrastructure is based on a relational data model.

5. The method of claim 4, wherein IT infrastructure elements are contained in the data representation and references are included in the data representation which are assigned to at least some of these IT infrastructure elements and reference files which include IT-infrastructure-element-related information.

6. The method of claim 4, wherein the data representation is structured in related layers corresponding to layers of the IT infrastructure.

7. The method of claim 1, wherein the IT infrastructure is located at an IT infrastructure site and the support service provider is located at a support service provider's site and wherein the data is transferred from the IT infrastructure site to the support service provider's site via a network connection.

8. The method of claim 1, wherein the comparing step comprises applying a difference algorithm to the data representations to be compared.

9. The method of claim 1, wherein the analysis step comprises analyzing the differences as to whether they relate to present or future functional behavior of the IT infrastructure.

10. The method of claim 1, wherein the analysis step comprises analyzing the differences as to whether they have an impact on present or future operability, performance, availability or security of the IT infrastructure.

11. The method of claim 10, wherein the results of the analysis step are categorized according to the severity of the impact indicated by them.

12. The method of claim 1, wherein the analysis step is based on predefined rules.

13. The method of claim 1, wherein the providing step comprises manifesting the analysis results in a human ore machine readable form.

14. The method of claim 1, wherein the providing step comprises outputting the results of the analysis step as a document.

15. The method of claim 1, wherein the providing step comprises automatically sending the results of the analysis step to an operator of the IT infrastructure.

16. A computer implemented method of providing remote support for an IT infrastructure by a support service provider, comprising the steps of:
receiving a data representation of at least part of the IT infrastructure which was obtained by collecting information within the IT infrastructure;
comparing the data representation with at least one previously received data representation so as to find differences between said data representations;
analyzing the differences found between said data representations;
providing the results of the analysis.

17. The method of claim 16, wherein the data representation of at least part of the IT infrastructure is based on a relational data model.

18. The method of claim 17, wherein IT infrastructure elements are contained in the data representation and references are included in the data representation which are assigned to at least some of these IT infrastructure elements and reference files which include IT-infrastructure-element-related information.

19. The method of claim 17, wherein the data representation is structured in related layers corresponding to layers of the IT infrastructure.

20. The method of claim 16, wherein the comparing step comprises applying a difference algorithm to the data representations to be compared.

21. The method of claim 16, wherein the analysis step comprises analyzing the differences as to whether they relate to present or future functional behavior of the IT infrastructure.

22. The method of claim 16, wherein the analysis step comprises analyzing the differences as to whether they have an impact on present or future operability, performance, availability or security of the IT infrastructure.

23. The method of claim 22, wherein the results of the analysis step are categorized according to the severity of the impact indicated by them.

24. The method of claim 16, wherein the analysis step is based on predefined rules.

25. The method of claim 16, wherein the providing step comprises manifesting the analysis results in a human ore machine readable form.

26. The method of claim 16, wherein the providing step comprises outputting the results of the analysis step as a document.

27. The method of claim 16, wherein providing step comprises automatically sending the results of the analysis step to an operator of the IT infrastructure.

28. A computer program product including program code for carrying out a method, when executed on a computer system, for providing remote support for an IT infrastructure by a support service provider, the program code being arranged to:
receive a data representation of at least part of the IT infrastructure which was obtained by collecting information within the IT infrastructure;
compare the data representation with at least one previously received data representation so as to find differences between said data representations;
analyze the differences found between said data representations;
provide the results of the analysis.

22. A computer system for providing remote support for an IT infrastructure by a support service provider programmed so that it acts as having the following functional components:
a receiving component for receiving a data representation of at least part of the IT infrastructure which was obtained by collecting information within the IT infrastructure;
a comparing component for comparing the data representation with at least one previously received data representation so as to find differences between said data representations;
an analysis component for analyzing the differences found between said data representations;
a providing component for providing the results of the analysis.
